(19) United States
(12) Patent Application Publication
(10) Pub. No.: US 2021/0357508 A1
(43) Pub. Date: Nov. 18, 2021

(54) METHOD AND A SYSTEM FOR TESTING MACHINE LEARNING AND DEEP LEARNING MODELS FOR ROBUSTNESS, AND DURABILITY AGAINST ADVERSARIAL BIAS AND PRIVACY ATTACKS

(71) Applicant: DEUTSCHE TELEKOM AG, Bonn (DE)

(72) Inventors: Yuval ELOVICI, Arugot (IL); Asaf SHABTAI, Hulda (IL); Oleg BRODT, Beer Sheva (IL); David MIMRAN, Tel Aviv (IL); Michael KHAVKIN, Beer Sheva (IL); Edita GROLMAN, Beer Sheva (IL)

(21) Appl. No.: 17/320,489

(22) Filed: May 14, 2021

Related U.S. Application Data
(60) Provisional application No. 63/025,200, filed on May 15, 2020.

(51) Int. Cl. G06F 21/57; G06N 20/00; G06F 11/36

(52) U.S. Cl. CPC G06F 21/577; G06N 20/00; G06F 2221/033; G06F 11/3612; G06F 11/3688

(57) ABSTRACT

A system for testing Machine Learning (ML) and deep learning models for robustness, and durability against adversarial bias and privacy attacks, comprising a Project Repository for storing metadata of ongoing projects each of which having a defined project policy, and created ML models and data sources being associated with the ongoing projects; a Secure Data Repository, for storing training and testing datasets and models used in each project for evaluating the robustness of the each project; a Data/Model Profiler for creating a profile, based on the settings and configurations of the datasets and the models; a Test Recommendation Engine for recommending the relevant and most indicative attacks/tests for each examined model and for creating indicative and effective test suites; a Test/Attack Ontology module for storing all attacks/tests with their metadata and mapping the attacks/tests to their corresponding settings and configurations; an Attack Repository for storing the implemented tests/attacks. An ML model is tested against each one of the robustness categories (privacy, bias and adversarial learning); a Test Execution Environment for Initializing a test suite, running multiple tests and prioritizing tests in the test suite; a Project/Test Analytics module for analyzing the test suite results and monitoring changes in performance over time; a Defenses Repository for storing implemented defense methods implemented for each robustness category.

### FIELD OF THE INVENTION

The present invention relates to the field of machine learning and deep learning models. More particularly, the present invention relates to a system and method for testing machine learning and deep learning models for robustness, and durability against adversarial bias and privacy attacks.

### BACKGROUND OF THE INVENTION

Machine learning (ML) has many applications and research directions. Nowadays, the majority of ML methods focus on improving the performance of the created models. There are several performance measurements for evaluating ML models, such as the accuracy (accuracy is defined as the percentage of correct predictions for the test data. It can be calculated easily by dividing the number of correct predictions by the number of total predictions), the precision (precision is defined as the number of true positives divided by the number of true positives plus the number of false positives) and the recall (a recall is a metric that quantifies the number of correct positive predictions made out of all positive predictions that could have been made) of the learned model. However, these conventional evaluation methods measure the performance of the created models without considering possible ethical and legal consequences that are related to sensitive information about the entities (usually user-related data) which might be discovered. Therefore, it is required to define performance measurements for evaluating possible ethical and legal aspects of ML models.

Data owners, such as organizations, are obliged to follow the Data Protection Directive (Commision, 2018) (officially Directive 95/46/EC of the European Union). First adopted in 1995, this directive regulates the processing of personal data and its movement within the European Union. Recently, the directive has been extended to the General Data Protection Regulation (GDPR), officially enforced on May 2018, presenting increased territorial scope, stricter conditions and broader definitions of sensitive data. Furthermore, this regulation contributes to increasing data transparency and empowerment of data subjects.

Many ML models try to solve different artificial intelligence (AI) tasks. Typically, it is required to detect and measure various entity (usually users) violations and the resilience of the induced model to them. It is also required to mitigate those risks in order to deploy a more resilient ML model for production usage. Mitigating the above risks introduces the challenging task of examining the trade-off between the performances of the model to its robustness against different types of abuse.

It is therefore an object of the present invention to provide a system and method for testing machine learning and deep learning models for robustness, bias and privacy.

It is another object of the present invention to provide a system and method for examining the robustness and resilience of AI-based tasks to adversarial attacks, biases and privacy violations.

Other objects and advantages of the invention will become apparent as the description proceeds.

### SUMMARY OF THE INVENTION

A system for testing Machine Learning (ML) and deep learning models for robustness, and durability against adversarial bias and privacy attacks, comprising:
a) a Project Repository for storing metadata of ongoing projects each of which having a defined project policy, and created ML models and data sources being associated with the ongoing projects;
b) a Secure Data Repository, for storing training and testing datasets and models used in each project for evaluating the robustness of the each project;
c) a Data/Model Profiler for creating a profile, based on the settings and configurations of the datasets and the models;
d) a Test Recommendation Engine for recommending the relevant and most indicative attacks/tests for each examined model and for creating indicative and effective test suites;
e) a Test/Attack Ontology module for storing all attacks/tests with their metadata and mapping the attacks/tests to their corresponding settings and configurations;
f) an Attack Repository for storing the implemented tests/attacks. An ML model is tested against each one of the robustness categories (privacy, bias and adversarial learning);
g) a Test Execution Environment for Initializing a test suite, running multiple tests and prioritizing tests in the test suite;
h) a Project/Test Analytics module for analyzing the test suite results and monitoring changes in performance over time; and
i) a Defenses Repository for storing implemented defense methods implemented for each robustness category.

The defined project policy may specify the acceptance criteria for bias, privacy and adversarial learning and define the minimum robustness score that is required for a model to be accepted and certified.

A project is considered completed after its corresponding the ML model is certified to comply with all the constrains of its corresponding policy.

States of a project may be selected from the group consisting of:
A Development state;
A Production state;
A Rollback state.

A training dataset may be used to induce a ML model and for evaluating the performance of the ML model.

Each attack/test may be evaluated relatively to a data source being a training or testing dataset and the evaluation outcome corresponds to the robustness of the model on the data source.

The Secure Data Repository may further comprise a Model Repository for storing model versions that reflect changes in an ML model.

Relevant tests to be executed on an examined model may be selected from the group of:
Model algorithm type;
Training data type;
Training data size;
Model implementation format/type.

The system may be implemented over a Fronted Management Server which is adapted to run the system modules and provide an API access for external command-line interface (CLI) and a frontend User Interface (UI) service that allows performing one or more system operations.

The system operations may include one or more of the following:
Creating new projects;
Creating new users;
Assigning new users to existing projects;
Assigning a policy to existing projects;
Creating new test suites;
Executing test suites;
Accessing analytics of projects or their test suites.

### BRIEF DESCRIPTION OF THE DRAWINGS

The above and other characteristics and advantages of the invention will be better understood through the following illustrative and non-limitative detailed description of preferred embodiments thereof, with reference to the appended drawings, wherein:

FIG. 1 shows a comparison between common performance KPIs to ethical and legal robustness KPIs;

FIG. 2 illustrates a full architecture of the system for testing machine learning and deep learning models for robustness, and durability against adversarial bias and privacy attacks, according to an embodiment of the invention;

FIG. 3 illustrates several model versions that can exist for each model in a project;

FIG. 4 shows an example screenshot of a possible state of the main page of a project in the UI of the system; and

FIG. 5 shows a screenshot of a possible state of test suite analytics main page, where a test suite of 8 different tests have been executed.

### DETAILED DESCRIPTION OF THE INVENTION

The present invention proposes a system for examining the robustness and resilience of various AI-based tasks to adversarial attacks, biases and privacy violations. The present invention provides a generic and adaptive testing environment, which can be integrated to Continuous Integration (CI—is a modern software development practice in which incremental code changes are made frequently and reliably. Automated build-and-test steps triggered by CI ensure that code changes being merged into the repository are reliable)/Continuous Delivery (CD—the automated delivery of completed code to environments like testing and development. CD provides an automated and consistent way for code to be delivered to these environments) processes.

The proposed system is capable of serving software developers during developing ML models. The proposed system is used to continuously certificate ML models according to a corporate policy of a project. This policy defines the criteria for the desired robustness levels (a machine learning model is considered to be robust if its output dependent variable is consistently accurate even if one or more of the input independent variables (features) or assumptions are drastically changed due to unforeseen circumstances) in each tested category: bias, privacy and adversarial learning.

For each one of the categories, the system provides different tests to examine the robustness levels. These tests are also referred to as attacks according to the category. The terms attacks or tests are used interchangeably: when testing for privacy breaches or adversarial learning, the tests are referred to as attacks, whereas when testing for unwanted bias, these attacks are referred as tests.

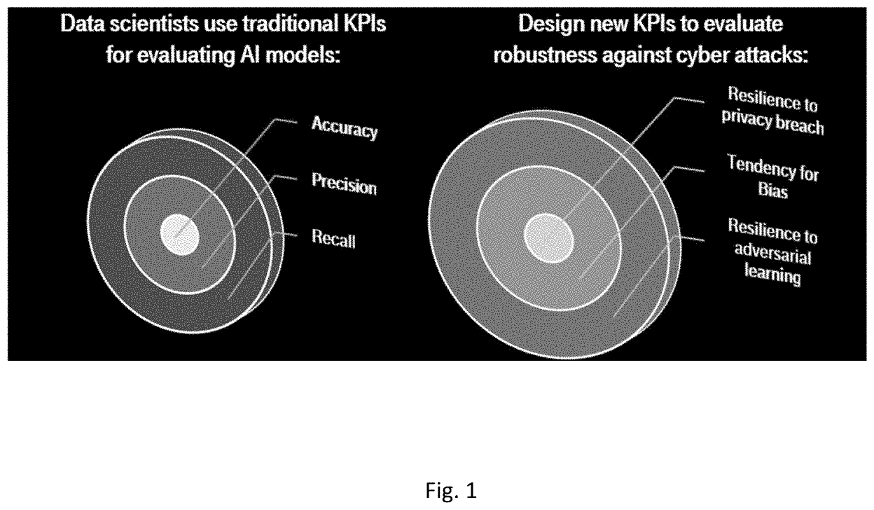

FIG. 1 illustrates the differences between conventional (standard) Key Performance Indicators (KPIs—a measurable values that demonstrate how effectively a company is achieving key business objectives. Organizations use KPIs at multiple levels to evaluate their success at reaching targets) and the new suggested KPIs of robustness, according to an embodiment of the invention.

The proposed system analyzes the following three categories:

Category 1: Privacy

This category represents the resilience of ML models to privacy breaches or the leakage of sensitive information.

Not only the data itself can reveal private sensitive information, but also the machine learning (ML) models that are induced from this data. An example for a scenario in which the ML model can reveal private information, is in the case of overfitting. Overfitting relates to a natural property of ML models, where learned patterns from the training data are “memorized” and “embedded” into the model, leading to a lack of generalization of these patterns when new unseen data is used by the model. This lack of generalization can lead to a substantial degradation in performance. Consequently, developers are more concerned about the side-effects of overfitting in ML models. The unintended memorization of data patterns in a created model can be beneficial to an adversary, to infer sensitive information.

It has been demonstrated (Fredrikson, et al.; Fredrikson, Jha, & Ristenpart, Model inversion attacks that exploit confidence information and basic countermeasures, 2015; Veale, Binns, & Edwards, 15 Oct. 2018) that ML models are vulnerable to a range of cybersecurity attacks that cause breaches of confidentiality, while violating the GDPR principals. These attacks compromise both the integrity of the ML model and its reputation following the model deployment to service.

In the case of ML-based systems, there are different types of privacy attacks (Papernot, McDaniel, Sinha, & Wellman , 24 Apr. 2018) (Veale, Binns, & Edwards, 15 Oct. 2018):
Membership inference: Determining whether a given data record was part of the model training dataset or not (Shokri, Stronati, Song, & Shmatikov, 2017).
Model extraction: Constructing a surrogate model with predictive performance on validation data, which is similar to the target model (Tranner, Zhang, Juels, Reiter, & Ristenpart, 2016).
Model inversion (attribute inference): A privacy breach that occurs if an adversary can infer the values of sensitive attributes. Such attacks are directed to take advantage of correlation between the unknown attributes and the model output or other dataset characteristics (Fredrikson, Jha, & Ristenpart, Model inversion attacks that exploit confidence information and basic countermeasures, 2015).
External information leakage: Training datasets may contain some implicit hidden properties which are not expressed as explicit attributes in the data. External information leakage attacks are directed to extract these hidden properties out of the datasets using the ML model (Ateniese, et al., 19 Jun. 2013).

Category 2: Bias

This category represents the tendency for bias in the predictions of ML models or in the data used to induce the ML model. Bias in machine learning (ML) is referred to misrepresentation of the population, on which the model is trained. Bias is represented by the presence of non-ethical discrimination towards any of the population groups distributed in the data. For example, bias may exist if male and female with the same properties are treated differently. Fairness is defined as the absence of any prejudice or favoritism toward an individual or a group based on their inherent or acquired characteristics. Unfair algorithm is an algorithm whose outcomes (i.e., predictions in ML models) are skewed toward a particular group of people (Mehrabi, Morstatter, Saxena, Lerman, & Galstyan, 23 Aug. 2019). Protected feature is a feature that can present unwanted discrimination towards its values, e.g., gender or race. Privileged value is a population group that historically had a systematic advantage, e.g., “men” is a privileged value in the “gender” protected feature. For example, in a fair ML model, when predicting whether a person is an engineer, the probability of identifying an engineer should be the same for female or male.

ML algorithms rely on the existence of sufficient, high quality training data. Obtaining high quality labeled data is an expensive, time-consuming task, which usually requires human efforts and expertise. Obtaining a sufficiently large dataset, which covers the entire properties of the domain in which the AI system is implemented, is quite complicated. Therefore, ML models are trained on a subsample of the entire population, assuming that any learned patterns and deductions on this small subsample can be generalized to the entire population. An example of non-generalization of datasets is when the data gathering process is not random and is sufficiently diverse, to cover the entire distribution in the population. When data instances are chosen non-randomly or without matching them to the nature of the instances used for prediction, the predictions of the ML models become biased toward the dominating group in the training population.

Additional reason for bias may be inherited in the training dataset itself, without being related to the data gathering process. It means that the data itself contains protected features with historically established privileged value. Moreover, examining the robustness and resilience of various AI-based tasks to bias requires examining what the ML model has learned. ML models may learn biased patterns which may influence its predictions even if the protected features are not explicitly defined.

Category 3: Adversarial Learning

This category represents the resilience of ML models to adversarial learning, since Machine learning (ML) algorithms can also be susceptible to adversarial abuse. Adversarial ML involves exploiting the vulnerabilities of the models to compromise Integrity, Availability and Confidentiality (Pfleeger & P., 2012) (Barreno, Nelson, Joseph, & Tygar, 2010).
Availability—is directed to attacks that are directed to preventing legitimate inputs from accessing the system or the outputs of its models, i.e., false positives. For example, an adversary may want to flag users as intrusions, that way preventing them from buying at a competitor's web store.
Integrity—is directed to attacks that are directed to approving hostile inputs into the system, thereby providing an adversary with access to the system and its outputs, i.e., false negatives. For example, an adversary may want to grant himself an administrator access to his competitor's web store and sabotage it.
Confidentiality—is directed to attacks that attempt to expose the structure or parameters of ML models. Compromising confidentiality can be defined with respect to the model itself, or its training data.

During adversarial learning attacks on ML models, existing weaknesses of the model are exploited to manipulate its outputs when new hand-crafted data examples are provided as inputs which are formed by applying small but intentional perturbations to them. Consequently, the ML models consistently misclassify these adversarial examples, and thereby, output an incorrect answer with high confidence. Moreover, adversarial examples often cannot be distinguished from their corresponding original examples by a human eye. The same adversarial example can usually fool a variety of classifiers with different architectures or trained on different subsets of the training data (Szegedy, et al., 21 Dec. 2013).

During a project life-cycle, the system proposed by the present invention allows software developers and data scientists to revise the models (if needed) and re-certificate them, until the models successfully pass all robustness and resilience tests. As a feedback, the proposed system provides the data scientist with suggestions for improving the robustness of the tested model and suggests defense mechanisms for increasing its resilience. In addition, the proposed system allows a transparent supervision and control of a project manager, starting with an initiation of a data science project up to its final approval and certification. Once the models have passed all tests, they can be safely deployed to their designated product.

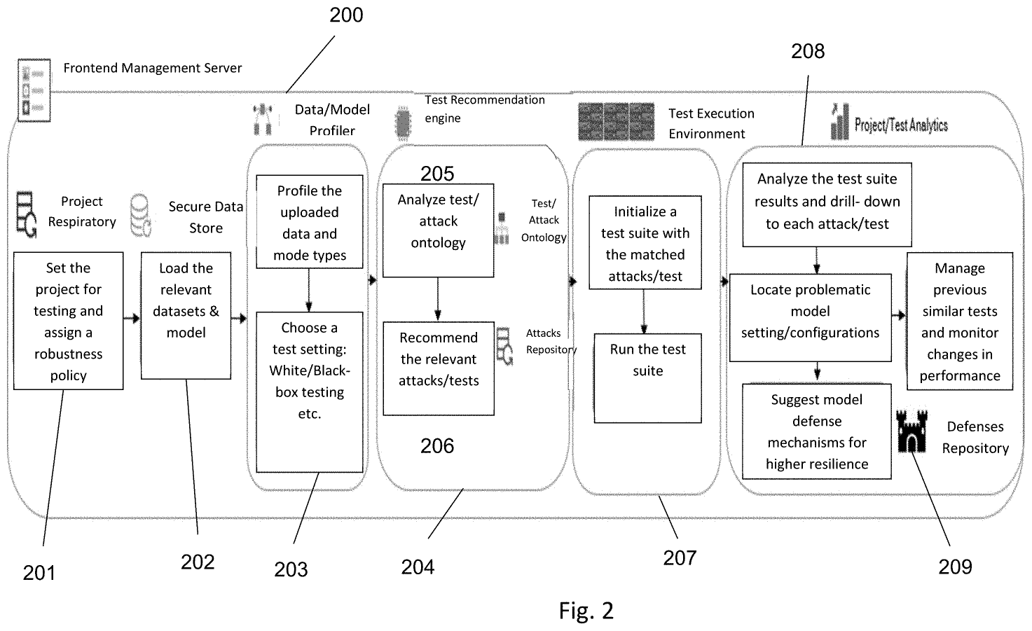

The full architecture of the system is illustrated in FIG. 2. The proposed system is implemented by a management server 200. The management server 200 operates the system and is adapted to generate both visual and text reports. In addition, the management server 200 provides a frontend service to create, execute and evaluate tests.

The management server 200 comprises a Project Repository 201 that contains ongoing projects that the data scientist is working on and stores their metadata. A project is the most general entity in the system and is characterized by a high-level goal, which states the main motivation for the project, with sub-tasks that should be completed. The created ML models and the data sources are associated with the defined project and correspond to its goals.

A project policy is attached to each project. A defined project policy specifies the acceptance criteria for each of the tested aspects: bias, privacy and adversarial learning. The project policy defines the minimum robustness score that is required for a model to be accepted and certified. A project is completed only when the ML model is certified to comply with all the constrains of its corresponding policy.

A project can be in different states, such as:
1. A Development state—at this state the models under the project are still under development and are continuously tested for robustness.
2. A Production state—at this state the project is completed, and all its related models are accepted and certified against the project policy. The models are deployed to service in a production environment. The life-cycle of the model is closed, until new issues about its robustness are raised.
3. A Rollback state—at this state robustness issues have been raised, rejecting the already deployed models. The rejected models are removed from production environments and are returned to development for further adjustments or a complete revision.

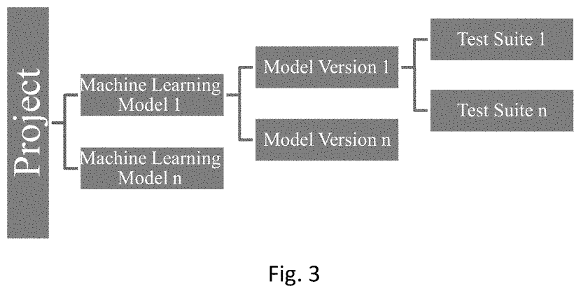

The management server 200 also comprises a Secure Data Repository 202 for storing the datasets and models used in each project, for further reuse. Both training dataset and testing datasets are stored and used for evaluating the robustness. An indexed secured repository is built for quick retrieval of datasets, which are a global resource in the system. Different data scientists, possibly working on different projects, have access to the same global datasets. Two types of data sources are stored in the repository, a training dataset and a testing dataset. A training dataset is a dataset which is used to induce a ML model, and therefore the model is highly dependent on it. The testing dataset is usually used for evaluating the performance of the ML model. In addition, the training and testing datasets are used to test violations of the examined categories. Each attack/test is evaluated relatively to a data source (training and testing dataset) and its final outcome corresponds to the robustness of the model on that specific data source. Therefore, a data science can verify his/her ML model on different data sources in order to increase the significance of the test results. The Secure Data Repository 202 also comprises a Model Repository since the ML model is the basic entity for a data scientist. Since an ML model is changing during its life-cycle, each change to the ML model creates a new model version. Each model version is an evolution of the initial model. The changes are made in attempt to improve the ML model performance and robustness. Changes to a ML model may be using a new training dataset, changes to model configuration, or changes to the type of its underlying algorithm etc. Each model version is associated with its parent model, for quick retrieval, in case of required revisions. Many model versions exist for each model in a project, as shown in FIG. 3. In addition to the compiled ML model, metadata and other configurations are also stored as additional information.

The management server 200 also comprises a Data/Model Profiler 203 that creates a profile, based on the settings and configurations of the datasets and the models. There are many factors for choosing the relevant tests to be executed on the examined model, for example:

1. Model algorithm type—the type of the algorithm that is used to build the ML model (e.g., Neural Network-based model (NN), rule-based model or general model, etc.).

2. Training data type—the type of data used for training the ML model (e.g., structured tabular data, unstructured image data, unstructured sequence audio data, etc.).

3. Training data size—the amount of data instances used for training the ML model. Models which are trained on small datasets are more challenging to test and may require additional data resources.

4. Model implementation format/type—the type of environment used for implementing the model algorithm (e.g., Python Keras-based (Chollet, 2015) neural network models, or Python ScikitLearn (Varoquaux, et al., 2015) general models, etc.).

The management server 200 also comprises a Test Recommendation Engine 204 that recommends the relevant and most indicative attacks/tests for each examined model. The test recommendation engine 204 is used to create indicative and effective test suites (a test suite is a collection of robustness tests which are executed as part of the same robustness category: privacy, bias or adversarial learning).

There are two main types for a ML model:
A Black-box ML model: In a black-box setting, the model is used in a query-response setting. The model is queried for its output without requiring any knowledge about its internal algorithm or its internal structure and configuration.
A White-box ML model: In a white-box setting, there is a complete access to the model internal structure and configuration.

The recommendation engine 204 matches the defined testing methodology according to the model type (e.g. black-box, white-box) and other properties of the model and the datasets (sources) and provides the data scientist with a list of recommended tests. The recommended tests are also the most indicative for the presence of robustness issues.

The management server 200 also comprises a Test/Attack Ontology 205 module that stores all attacks/tests with their metadata and maps the attacks/tests to their corresponding settings and configurations.

The management server 200 also comprises an Attack Repository 206 that stores the implemented tests/attacks. An ML model is tested against each one of the robustness categories (privacy, bias and adversarial learning). The implementations of the attacks/tests are stored in the designated repository, and are also indexed, for quick retrieval. In addition, the tests are categorized according to the properties of examined model and its datasets.

The management server 200 also comprises a Test Execution Environment 207 that Initializes a test suite, which is a collection of several attacks/tests that corresponds to the examined model. The test execution environment 207 is a distributed computing environment for running multiple tests. Since each test involves different computational resources, tests can run for a different amount of time. Hence, the test execution environment 207 is responsible for prioritizing the tests in the test suite and scheduling their execution. Resources and running time for each test are monitored by the testing environment for improving its efficiency.

The management server 200 also comprises a Project/Test Analytics module 208 that analyzes the test suite results and drill-down to each attack/test result and provides project test level results, analytics and defense mechanisms for the tested model to increase its resilience. The Project/Test Analytics module 208 manages previous similar tests and monitors changes in performance over time. This allows the system 200 to provide both a high-level and a detailed analysis tools for monitoring the progress of the project in terms of robustness certification. A more detailed report (“drill-down”) can be generated.

Examples of the report contents are:
Project State—describes the state of the project (i.e., development, production or rollback).
Executed Test Suites—a summary of the recent executed test suites (with respect to the given project).
Testing Coverage—coverage of executed tests in each testing category (privacy, bias or adversarial learning), out of all the available tests in the test/attack repository. Full coverage is considered when all available tests have been executed.
Project Total Score—the total score which reflects the resilience of the related models of the project.
Robustness-Performance Tradeoff—the tradeoff between the robustness of each tested category (i.e., resilience to privacy breaches, bias and adversarial learning) and its influence on the performance of the model (i.e., accuracy/precision/recall).

### Test Suite Analytics

The system provides a detailed analysis of each executed test suite, for example:
Tests summary—summary of executed tests within the given test suite. A score is attached to each test, which reflects the level of robustness of the ML model to the executed test (i.e., an attack).
Test suite statistics—a summary of test suite statistics, containing information about test suite testing settings, information about the examined model and its related data sources.
Detailed test results—detailed statistics and results of each executed test in the test suite.

### Mitigation Defenses

In case of failed tests, the system locates possible problematic model settings/configurations and proposes relevant defense mechanisms for mitigating the corresponding vulnerabilities out of the available defenses in the defenses repository. The data scientist can choose which defense mechanism to apply on his ML model and analyze its effectiveness. As a re-certification step, the system enables re-running the last failed test suite for conforming the increase in the model resilience with respect to the tested robustness category.

The management server 200 also comprises a Defenses Repository 209 that stores the implemented defense methods. To mitigate possible issues with the robustness of the ML models, defenses are implemented and stored in the defense repository. The defenses are implemented for each robustness category (privacy, bias or adversarial learning) and can be applied on vulnerable ML models as a mitigation step towards a successful certification of the model.

The Fronted Management Server 200 is responsible for activating the relevant entities in the different flows in the system. It provides an API access for external command-line interface (CLI), or other third-parties who may use the system. In addition, a frontend User Interface (UI) service allows performing the previously described system operations. For example:
Creating new projects
Creating new users
Assigning new users to existing projects
Assigning a policy to existing project
Creating new test suites
Executing test suites
Accessing analytics of projects or their test suites

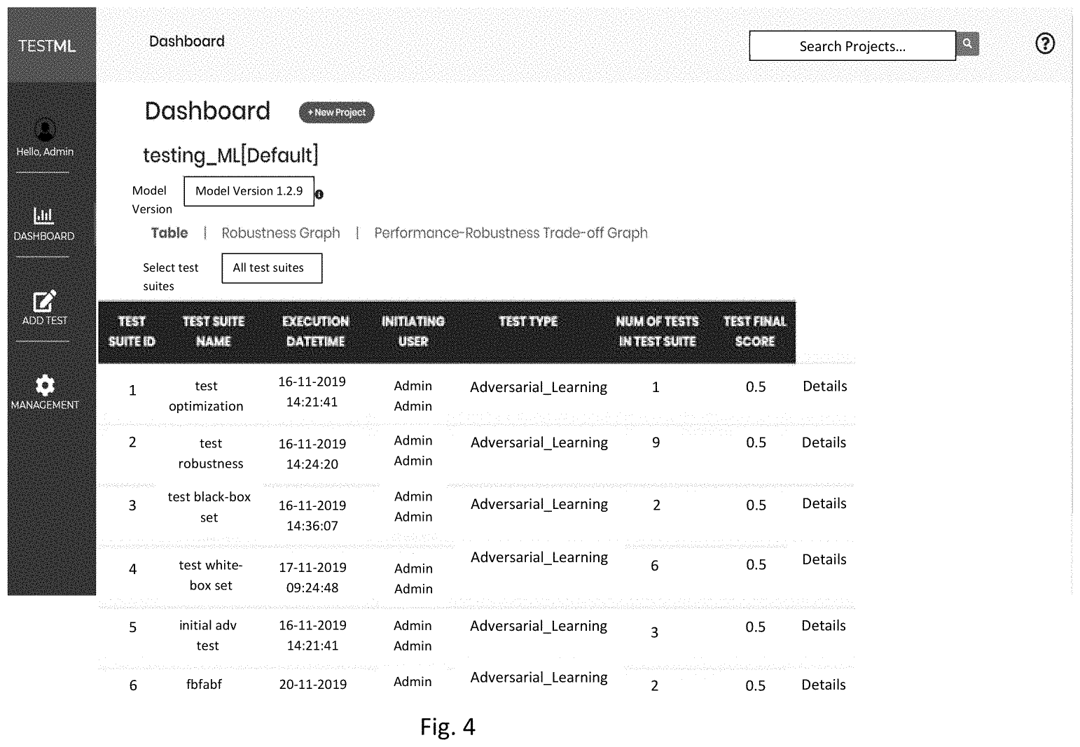

FIG. 4 shows an example screenshot of a possible state of the main page of a project in the UI of the system.

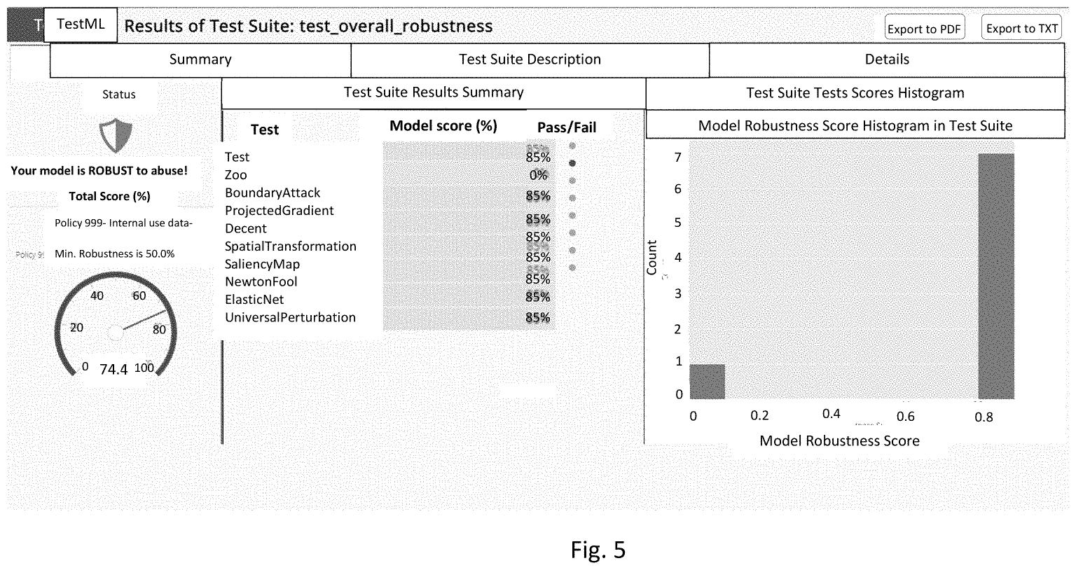

FIG. 5 shows a screenshot of a possible state of test suite analytics main page, where a test suite of 8 different tests have been executed.

Although embodiments of the invention have been described by way of illustration, it will be understood that the invention may be carried out with many variations, modifications, and adaptations, without exceeding the scope of the claims.

### REFERENCES

Ateniese, G., Felici, G., Mancini, L. V., Spognardi, A., Villani, A., & Vitali, D. (19 Jun. 2013). Hacking smart machines with smarter ones: How to extract meaningful data from machine learning classifiers. arXiv preprint arXiv:1306.4447.

Barreno, M., Nelson, B., Joseph, A. D., & Tygar, J. D. (2010). The security of machine learning. Machine Learning, 8(12), 121-148.

Chollet, F. (2015). Keras.

Commision, E. (2018). EU data protection rules. (European Commision) Retrieved from https://ec.europa.eu/commission/priorities/justice-and-fundamental-rights/data-protection/2018-reform-eu-data-protection-rules/eu-data-protection-rules_en

Fredrikson, M., Jha, S., & Ristenpart, T. (2015). Model inversion attacks that exploit confidence information and basic countermeasures. Proceedings of the 22nd ACM SIGSAC Conference on Computer and Communications Security, 1322-1333.

Fredrikson, M., Lantz, E., Jha, S., Lin, S., Page, D., & Ristenpart, T. (n.d.). Privacy in pharmacogenetics: An end-to-end case study of personalized warfarin dosing. 23rd {USENIX} Security Symposium ({USENIX} Security 14), 17-32.

Mehrabi, N., Morstatter, F., Saxena, N., Lerman, K., & Galstyan, A. (23 Aug. 2019). A Survey on Bias and Fairness in Machine Learning. arXiv preprint arXiv:1908.09635.

Papernot, N., McDaniel, P., Sinha, A., & Wellman , M. P. (24 Apr. 2018). SoK: Security and privacy in machine learning. In 2018 IEEE European Symposium on Security and Privacy (EuroS&P) (pp. 399-414). IEEE.

Pfleeger, S. L., & P., P. C. (2012). Analyzing Computer Security: A Threat/Vulnerability/Countermeasure Approach. Prentice Hall Professional.

Shokri, R., Stronati, M., Song, C., & Shmatikov, V. (2017). Membership inference attacks against machine learning models. 2017 IEEE Symposium on Security and Privacy (SP), 3-18.

Szegedy, C., Zaremba, W., Sutskever, I., Bruna, J., Erhan, D., Goodfellow, I., & Fergus, R. (21 Dec. 2013). Intriguing properties of neural networks. arXiv preprint arXiv:1312.6199.

Tramèr, F., Zhang, F., Juels, A., Reiter, M. K., & Ristenpart, T. (2016). Stealing machine learning models via prediction apis. 25th {USENIX}Security Symposium ({USENIX} Security 16), 601-618.

Varoquaux, G., Buitinck, L., Louppe, G., Grisel, D., Pedregosa, F., & Mueller, A. (2015). Scikit-learn: Machine learning without learning the machinery. GetMobile: Mobile Computing and Communications, 19(1), 29-33.

Veale, M., Binns, R., & Edwards, L. (15 Oct. 2018). Algorithms that remember: model inversion attacks and data protection law. Philosophical Transactions of the Royal Society A: Mathematical, Physical and Engineering Sciences 376(2133), 20180083.

1. A system for testing Machine Learning (ML) and deep learning models for robustness, and durability against adversarial bias and privacy attacks, comprising:
a) a Project Repository for storing metadata of ongoing projects each of which having a defined project policy, and created ML models and data sources being associated with said ongoing projects;
b) a Secure Data Repository, for storing training and testing datasets and models used in each project for evaluating the robustness of said each project;
c) a Data/Model Profiler for creating a profile, based on the settings and configurations of the datasets and the models;
d) a Test Recommendation Engine for recommending the relevant and most indicative attacks/tests for each examined model and for creating indicative and effective test suites;
e) a Test/Attack Ontology module for storing all attacks/tests with their metadata and mapping the attacks/tests to their corresponding settings and configurations;
f) an Attack Repository for storing the implemented tests/attacks. An ML model is tested against each one of the robustness categories (privacy, bias and adversarial learning);
g) a Test Execution Environment for Initializing a test suite, running multiple tests and prioritizing tests in said test suite;
h) a Project/Test Analytics module for analyzing the test suite results and monitoring changes in performance over time; and
i) a Defenses Repository for storing implemented defense methods implemented for each robustness category.

2. A system according to claim 1, wherein the defined project policy specifies the acceptance criteria for bias, privacy and adversarial learning and defines the minimum robustness score that is required for a model to be accepted and certified.

3. A system according to claim 1, wherein a project is completed after its corresponding the ML model is certified to comply with all the constrains of its corresponding policy.

4. A system according to claim 1, wherein states of a project are selected from the group consisting of:
A Development state;
A Production state;
A Rollback state.

5. A system according to claim 1, wherein a training dataset is used to induce a ML model and for evaluating the performance of the ML model.

6. A system according to claim 1, wherein each attack/test is evaluated relatively to a data source being a training or testing dataset and the evaluation outcome corresponds to the robustness of the model on said data source.

7. A system according to claim 1, wherein the Secure Data Repository further comprises a Model Repository for storing model versions that reflect changes in an ML model;

8. A system according to claim 1, wherein relevant tests to be executed on an examined model are selected from the group of:
Model algorithm type;
Training data type;
Training data size;
Model implementation format/type.

9. A system according to claim 1, implemented over a Fronted Management Server being adapted to run the system modules and provide an API access for external command-line interface (CLI) and a frontend User Interface (UI) service that allows performing one or more system operations.

10. A system according to claim 1, wherein the system operations include one or more of the following:
Creating new projects;
Creating new users;
Assigning new users to existing projects;
Assigning a policy to existing projects;
Creating new test suites;
Executing test suites;
Accessing analytics of projects or their test suites.
